(19) United States
(12) Patent Application Publication
(10) Pub. No.: US 2011/0191958 A1
(43) Pub. Date: Aug. 11, 2011

(54) Lithotomy position afterloading carbon fiber treatment couch under image guidance

(75) Inventor: Yonglin Fan, Sichuan (CN)

(73) Assignee: Sichuan Ruidi Medical Science and Technology Co., Ltd.

(21) Appl. No.: 13/019,267

(22) Filed: Feb. 1, 2011

(30) Foreign Application Priority Data
Feb. 9, 2010 (CN) 201020110658.5

(51) Int. Cl. A61G 13/02; A61G 13/12

(52) U.S. Cl. 5/601

(57) ABSTRACT

A lithotomy position afterloading carbon fiber treatment couch used in image guiding comprises an afterloading treatment couch board, a source applicator fixing bracket, a left and a right leg fixator The left and right leg fixator comprise a mounting board, an axis sleeve and a leg support respectively. On the couch board is provided an adjustable headrest board. At the other end of the couch board is provided with a source applicator fixing bracket. On the adjustable headrest board is provided a resinous headrest and a headrest adjustment panel. The mounting board of the left and right leg fixator is movably connected to two corners of the same side of the couch board respectively. On the mounting board of the left and right leg fixator are provided leg supports respectively and symmetrically. The leg supports are provided with banding tapes. At two sides of the couch board are provided guideways.

### BACKGROUND

1. Technical Field

The present invention pertains to the field of clinical medical apparatus, particularly, to a lithotomy position afterloading carbon fiber treatment couch under image guidance.

2. Brief Description of Related Arts

As technologies develop, the newest tumor intracavitary radiation therapy (afterloading) technology requires to be carried out under image guidance. The international conventional way is to equip the afterloading treatment room with an X-ray imaging C-arm CT to take images. However, due to the expensive price, most domestic hospitals cannot afford the special equipment for afterloading treatment, and therefore greatly limit the application of the technology nationally. To solve this issue, we designed and made the present apparatus. Its characteristics is that it is comprised of a movable flat board made of carbon fiber materials, a detachable fixing bracket and leg fixators installed on the flat board. The bracket is used for supporting and fixing the source applicator inside patient's body and at the same time is adaptable to CT and MRI scanning, so that it can replace the metal fixing bracket of previous source applicators, and the leg fixators can ensure the comfortability of patients' fixed position. By means of this fixing device, the consistency of the relative position of patient's part and source applicators can be guaranteed; therefore, the C-arm CT can be replaced with conventionally equipped diagnosis-purposed CTs and MRIs of conventional hospitals to guide images and accordingly obtain the images; in addition, the image data will be taken as the basis for treatment plans. Because the relative position of the patients' position and the source applicator is fixed during the process of CT and MRI scanning and afterloading treatment, which ensures the consistency, the treatment plan is implemented under a reliable image guidance; thus, it is still possible to apply the afterloading intensity-modulated radiation therapy (hereinafter “IMRT”) under the condition with the difficulty equipping a special C-arm CT for image guidance.

### SUMMARY OF THE PRESENT INVENTION

The objective of the present invention is to furnish a lithotomy position afterloading carbon fiber treatment couch under image guidance, which is adaptable to scanning and locating of CT and MRT and is capable of firmly fixing the source applicator and patients' position so that keeping the consistency of the relative position of the source applicator and the patients' position during the whole process of CT and MRT locating and source application therapy, and finally achieving the requirement of precise afterloading IMRT.

According to the present invention, the treatment couch comprises an afterloading treatment couch board, a source applicator fixing bracket, a left leg fixator and a right leg fixator. The left leg fixator and the right leg fixator comprise a mounting board, an axis sleeve and a leg support, respectively. On the afterloading treatment couch board is provided an adjustable headrest board. At the other end of the afterloading treatment couch board is provided a source applicator fixing bracket. On the adjustable headrest board is provided a resinous headrest and a headrest adjustment panel for adjusting the position of the resinous headrest. The mounting board of the left leg fixator and the right fixator is movably connected to two corners of the same side of the afterloading treatment couch board, respectively. On the mounting board of the left leg fixator and the right fixator are respectively and symmetrically provided leg supports. The leg supports are provided with banding tapes. At two sides of the afterloading treatment couch board are provided guideways. Fixed blocks are embedded into the guideways. At one side of the afterloading treatment couch board are also provided afterloading treatment fixing films.

At the two corners of the same side of the afterloading treatment couch board are respectively and symmetrically provided two revolving axises, so as to cooperate with the two axis sleeves at the mounting board of the left leg fixator and the right leg fixator.

The headrest adjustment panel set at least three positions.

The source applicator fixing bracket is set at the middle place of one end of the afterloading treatment couch board.

To sum up, the present invention has the following advantages:

1. The afterloading treatment couch is made of carbon fiber. Because carbon fiber has the property of lightweight, high stiffness, and not producing artifacts to CT and MRI scan and location, it meets the requirement that the afterloading treatment couch board must be capable of supporting body's weight and still not deflected, and will not produce artifacts during CT and MRI scanning and locating.

2. The source applicator fixing bracket can be conveniently adjusted to further adjust and fix the position of the source applicator, so that a proper and firm position for fixing the source applicator can be determined.

3. Because the source applicator bracket is firmly secured to and integrated with the afterloading treatment couch board through the fixed guideways and location key grooves of the afterloading treatment couch board, the consistency of the relative position of the source applicator and body can be guaranteed, and therefore the requirement of precise afterloading IMRT radiation therapy can be achieved.

4. By means of leg fixators and adjustable headrest set on the afterloading treatment couch board, different bodies can be adjusted reliably, so as to keep the consistency of the relative position of the source applicator and the human body during the whole process of source application therapy.

5. Because the relative position of patients' position and source applicators are fixed during the whole process of CT, MRI scanning, and afterloading treatment, which guarantees the consistency, treatment plans can be implemented under reliable image guidance, and therefore it is viable to apply afterloading IMRT under the condition with difficulty equipping special C-arm CTs for image guidance.

### BRIEF DESCRIPTION OF DRAWINGS

FIG. 1 is the front view of the present invention.

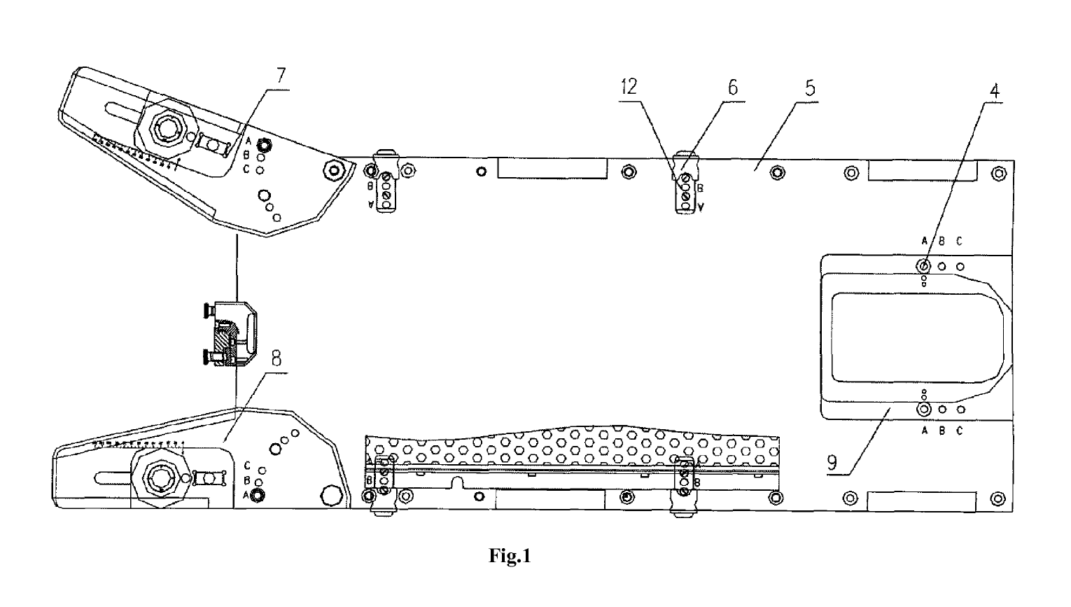

FIG. 2 is the bottom view of the present invention, after removing the leg fixator.

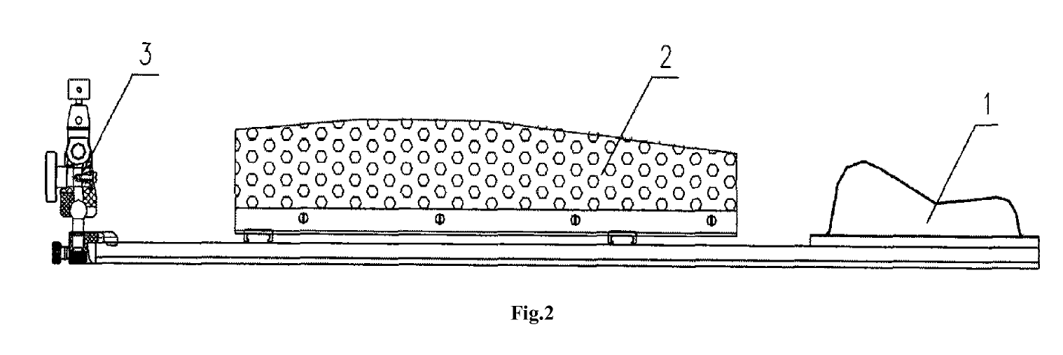

FIG. 3 is the section view of the fixator of the left leg of the present invention.

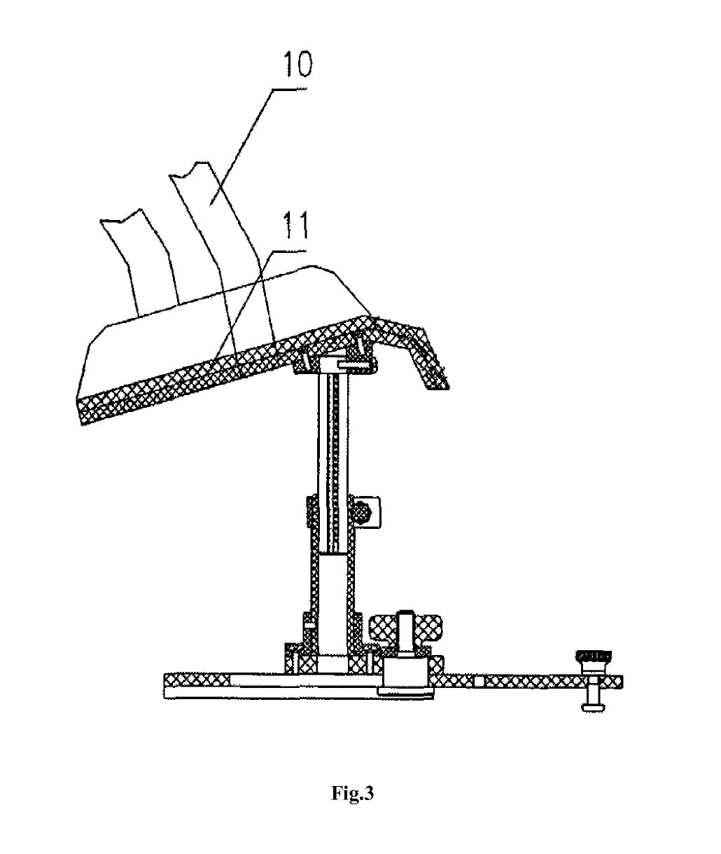

In the drawings, 1 denotes resinous headrest; 2—afterloading treatment fixing film; 3—source applicator fixing bracket; 4—headrest adjustment panel; 5—afterloading treatment couch board; 6—guideway; 7—right leg fixator; 8—left leg fixator; 9—adjustable headrest; 10—banding tape; 11—leg support; 12—fixed block.

### DETAILED DESCRIPTION OF PREFERRED EMBODIMENTS

The drawings will be combined with the following embodiments to describe the present invention in detail.

As shown in drawings, the lithotomy position afterloading carbon fiber treatment couch under image guidance comprises an afterloading treatment couch board 5, a source applicator fixing bracket 3, a left leg fixator 8 and a right leg fixator 7. The left leg fixator 8 and the right leg fixator 7 comprise a mounting board, an axis sleeve and a leg support, respectively. An adjustable headrest 9 is set on the afterloading treatment couch board 5. A source applicator fixing bracket 3 is set at the other end of the afterloading treatment couch board 5. The adjustable headrest is set with a resinous headrest 1 and a headrest adjustment panel 4. The mounting board of the left leg fixator 8 and the right leg fixator 7 is movably connected to two corners at the same side of the afterloading treatment couch board 5, respectively; the mounting board of the left leg fixator 8 and the right leg fixator 7 is provided with a leg support 11, respectively and symmetrically; the leg support 11 is provided with banding tapes 10. On the two sides of the afterloading treatment couch board 5 are set guideways 6; fixed blocks 12 are embedded inside the guideways 6. On one side of the afterloading treatment couch board 5 are set afterloading treatment fixing films 2.

The afterloading treatment couch board 5 is set with revolving axises at two corners of the same side thereof, respectively and symmetrically; the mounting boards of the left leg fixator 8 and the right leg fixator 7 are respectively set with an axis sleeve for cooperating with the revolving axises. The headrest adjustment panel 4 is set with three positions. The source applicator fixing bracket 3 is set at the middle place of one end of the afterloading treatment couch board 5.

The afterloading treatment couch board is set with the above-described leg fixators. The leg fixators are secured through the revolving axises to the couch board and can revolve at different positions, and then fixed through a detachable tension bridle pin. The leg fixators are installed with slidable blocks for controlling the length direction of the human body. The leg fixators are installed with axis sleeves so that the leg supports can be revolved, be stretched and shortened. On the other end of the afterloading treatment couch board are set three position holes A, B, C, so that the adjustable headrest board can be fixed through the convenient tension bridle pin to the couch board, and the resinous headrest can be fixed through location pins of the adjustable headrest board. The lithotomy position afterloading carbon fiber treatment couch of the present invention brings together many clinical use functions; the source applicator fixing bracket is for fixing the source applicator and ensuring the consistency of the treated part and the body position; the leg fixator is for fixing legs and lifting and lowering, and opening and closing legs, which is helpful for clinical operations; the adjustable resinous headrest is for putting the head in a fixed position.

The above-described measure has solved the problem that the relative position of patients' position and treated part thereof cannot be kept consistently during the whole process of CT or MRI scanning and afterloading treatment, and therefore has provided a possibility of applying the new technology, clinical radiation therapy.

Even though the drawings are combined with the embodiments to describe the present invention, any various modification or changes made by the skills in the art without creative works, within the claimed range of the following claims, should belong to the protection of the present application.

What is claimed is:

1. A lithotomy position afterloading carbon fiber treatment couch under image guidance, comprising
an afterloading treatment couch board (5);
a source applicator fixing bracket (3);
a left leg fixator (8) and a right leg fixator (7),
wherein the left leg fixator (8) and the right leg fixator (7) comprises a mounting board, an axis sleeve and a leg support, respectively;
on the afterloading treatment couch board (5) is provided an adjustable headrest board (9);
at the other end of the afterloading treatment couch board (5) is provided a source applicator fixing bracket (3);
on the adjustable headrest board (5) is provided a resinous headrest (1) and a headrest adjustment panel (4) for adjusting the position of the resinous headrest;
the mounting board of the left leg fixator and the right fixator is movably connected to two corners of the same side of the afterloading treatment couch board, respectively;
on the mounting board of the left leg fixator and the right fixator is respectively and symmetrically provided a leg support (11);
the leg support (11) is provided with banding tapes (10);
at the two sides of the afterloading treatment couch board (5) are also provided guideways (6);
fixed blocks (12) are embedded into the guideways;
at one side of the afterloading treatment couch board (5) are provided afterloading treatment fixing films (2).

2. The lithotomy position afterloading carbon fiber treatment couch under image guidance set forth in claim 1, wherein at the two corners of the same side of the afterloading treatment couch board (5) are respectively and symmetrically provided a revolving axis, so as to cooperate with the two axis sleeves at the mounting boards of the left leg fixator and the right leg fixator.

3. The lithotomy position afterloading carbon fiber treatment couch under image guidance, wherein the headrest adjustment panel (4) set at least three positions.

4. The lithotomy position afterloading carbon fiber treatment couch under image guidance, wherein the source applicator fixing bracket is set at the middle place of one end of the afterloading treatment couch board (5).
